(19) United States
(12) Patent Application Publication
(10) Pub. No.: US 2005/0179921 A1
(43) Pub. Date: Aug. 18, 2005

(54) Method, apparatus and program product for device independent print job ticketing

(75) Inventors: Craig Duray Brossman, Boulder, CO (US); Carl Michael Dennison, Longmont, CO (US); Ronald L. Heiney, Longmont, CO (US); Brian William Moroney, Longmont, CO (US); Dwight Ross Palmer, Longmont, CO (US); Adam A. Swartz, Thornton, CO (US); Garrett L. Thompson, Longmont, CO (US); John Stuart Walker, Boulder, CO (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/065,526

(22) Filed: Oct. 25, 2002

Related U.S. Application Data
(60) Provisional application No. 60/337,693, filed on Oct. 26, 2001.

(51) Int. Cl. G06F 15/00

(52) U.S. Cl. 358/1.13; 358/1.9

(57) ABSTRACT

A user is allowed to select desired options with respect to a print source file in a device independent manner. Selected options are stored in a device-independent way in a job ticket. When a printer is selected, the print application according to the invention reads the job ticket and a printer capability file (associated with the selected printer), converts the device-independent attributes from the job ticket into device specific printer commands from the capability file, and incorporates the printer commands into the printable format, as appropriate for the file.

### CROSS REFERENCE TO RELATED APPLICATIONS

This application claims priority from Provisional Application Ser. No. 60/337,693 filed 26 Oct. 2001.

### BACKGROUND OF INVENTION

The present invention relates to modern, high-function printers with computer-like interfaces and peripherals like storage, etc. More specifically, the invention relates to selecting and storing print job attributes in a way that is device independent.

Each printer manufacturer has a unique set of device dependent printer commands to support options such as covers, paper substitutions, finishing options, etc. Today, when printing a document, an operator must select the printer, bring up dialogues, set all the desired job attributes and then print the job. This must be done for each printer, the options can only be used for that specific printer, and the options are often not saved.

Also, current print job ticketing solutions are generally printer or printer-family specific such that any ticketing settings will only work on a small set of printers. Also, each brand or family or printers typically has its own ticketing application. This forces an operator to re-ticket a job every time it is to be printed on a printer from a different printer family, and to do so using a different ticketing application, such as Xerox”s XDS or IBM”s Print File Downloader. In multi-vendor print environments this re-ticketing requirement requires that an operator must know how to use multiple ticketing applications, understand how to ticket the job such that the same output results from the different printers and expend the time and effort to re-ticket the job.

There is a need in the field for a way to set printing options associated with a print source file in a way that is independent of the device on which the file is to be printed. These options should be set using one standard application or end user interface and stored in a way they can be easily recalled and associated with the correct print source file. When the file is to be printed, the printing options should be transparently converted into the correct device dependent print options for the selected printer.

### SUMMARY OF INVENTION

It is a purpose of the present invention to allow a user to select desired options with respect to a print source file, such as a .pdf file or a file in any other printable format in a device independent manner. Selected options are stored in a device-independent way in a job ticket. These selections are made prior to selecting the printer. Later, when a printer is selected, the print application according to the invention reads the job ticket and a printer capability file (associated with the selected printer), converts the device-independent attributes from the job ticket into device specific printer commands from the capability file, and incorporates the printer commands into the printable format, as appropriate for the file. The printer capability file also provides a mechanism for configuration of device options and exception reporting when a printer does not support any specific job ticket option or does not have a certain feature installed.

### BRIEF DESCRIPTION OF DRAWINGS

Some of the purposes of the invention having been stated, others will appear as the description proceeds, when taken in connection with the accompanying drawings, in which:

FIG. 1 is a schematic illustration of an information handling system associated with a printer;

FIG. 2 is a schematic representation of a screen display associated with implementation of this invention;

FIG. 3 is another schematic representation of a screen display associated with implementation of this invention;

FIG. 4 is a schematic representation of the steps in implementing the present invention; and

FIG. 5 is a representation of a computer readable medium bearing program instructions in accordance with the present invention.

### DETAILED DESCRIPTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

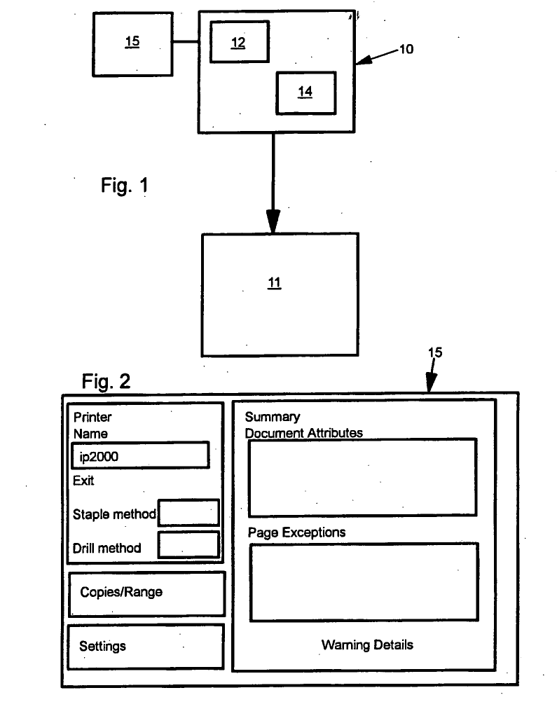

Referring now to FIG. 1, an information handling system implementing the present invention is there shown at 10 with an associated high feature printer 11. The system 10 has a processor 12, associated memory 14, and a display 15. Appropriate operator manipulated input devices such as a keyboard or pointing device are provided as well known in the applicable arts, but are not illustrated as being well known. By using the input devices, an operator may cause the system 10 to retrieve and execute programs and operate on data files which may be stored in the memory 14 or otherwise be accessible to the processor 12 as through a network, from a removable disk or the like.

The preferred embodiment of the invention stores job ticket data in an XML file and uses XML-based printer capability files to specify which features are available for a particular printer, the range of allowed values for specified options, and the printer-specific commands needed to execute each option. The choice of options is taken from a device-independent description, such as a job ticket or print submission user interface. The following examples illustrate the preferred embodiment of the invention. Persons skilled in the applicable arts will recognize that other methods of achieving these results could be implemented without departing from the spirit of the invention.

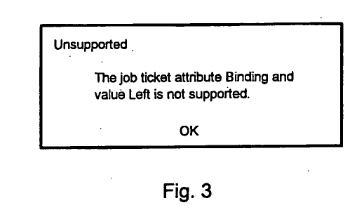

When the user selects a set of print options and a specific printer, the invention checks the selected options against the printer's capability file. If the options are allowed, then the invention extracts the printer-specific commands corresponding to the options and sends them to the printer. If the options are not allowed, or the combination of options is not allowed, then the invention reports the problem to the user as a printer mismatch via the production print dialog or other method. FIGS. 2 and 3 illustrate screen displays, in simplified form for ease in illustration, which will be displayed to the user during implementation of this invention.

In FIG. 2, the display will indicate to a user the name of a selected printer and will offer options to select other printers in a multi-printer environment. That is, a print facility as contemplated by this invention will have a number of printers with varying capabilities (some of which are illustrated in tables later in this disclosure). The user must select a printer having capabilities matching the requirements of particular print job, and one purpose of this invention is to guide the user in making a proper selection. As indicated in FIG. 2, the user may be able, in selecting a particular printer, to select certain characteristic capabilities, such as a method a stapling or drilling the printed product. A Summary field displays attributes assigned to the print job as the job is ticketed. If the invention as described more fully hereinafter notes exceptions for pages, a warning will appear for an indicated page and, by selecting a Warning Details button, the user may display details of any warnings as shown in FIG. 3. As is conventional user may select a range of pages to be printed and the number of copies to be made.

| | |
|---|---|
| Xerox | %XRXedgeStitching: SinglePortrait |
| IBM | %%+ staple(front) |
| | %KDKRotation: 0 |
| Canon | <PrinterCommand Cmd=“EFStapler” |
| | Parameter=“PUpperLeft”/> |

The Canon is a PostScript device and uses the PPD mechanism to determine printer commands. The values of EFStapler and PUpperLeft are sent to the PPD processor and produce an actual device specific PostScript Command.

The capabilities files for the three printers would each have an entry for the device-independent stapling option, connecting it to the specific printer commands:

```
Xerox:
<Element Name=“Finishing”>
  <Attribute Name=“StitchingPosition” Value=“TopLeft”>
    <PrinterCommand Cmd=“%XRXedgeStitching: SinglePortrait”/>
  </Attribute>
</Element>
IBM:
<Element Name=“Finishing”>
  <Attribute Name=“StitchingPosition” Value=“TopLeft”>
    <PrinterCommand Cmd=“%%+ staple(front)”/>
    <PrinterCommand Cmd=“%KDKRotation: 0”/>
  </Attribute>
</Element>
Canon:
<Element Name=“Finishing”>
  <Attribute Name=“StitchingPosition” Value=“TopLeft”>
    <PrinterCommand Cmd=“EFStapler” Parameter=“PUpperLeft”/>
  </Attribute>
</Element>
```

The capability file contains an entry for every allowable device-independent option that the specific printer supports. The printer driver software need not know anything about the details of a particular printer because they are completely contained in the capabilities file.

In addition to mapping from device-independent options to printer-specific commands, the invention also provides a mechanism for determining and reporting an exception (in the appropriate area of the display of FIG. 2, for example) if a device option was specified and the feature is not supported or is not installed on the specific printer. There are three types of error exceptions: the option or value is not supported by the print engine. For example, front and back cover pages are supported by the Xerox 6135 and IBM 2000, only front cover pages are supported on the Canon 600, the Xerox DocuColor 12 does not support covers at all. If the user specifies a back cover in the job ticket, the invention would generate an error exception when printing to the DocuColor 12 or Canon 600, and it would generate the appropriate printer-specific command for the Xerox 6135 and IBM 2000. the option or value is supported by the print engine, but the selected feature is not installed on the particular destination printer. For example, the printer model supports stapling but the particular printer does not have the stapler feature installed, so the invention generates an error exception. These conditions might be called “Constraints”. the option or value exceeds the device limit. For example, if the job asks for six different paper types but the printer has only four input trays, then the invention generates an error exception. These conditions might be called “Limits”.

The invention can report these error exceptions in any or all of the following conditions: when the user selects a particular printer, when the user submits the job to print, when the user invokes a “report exceptions” function from the user interface, for example resulting in the display of FIG. 3.

An XML file might be used to specify configuration options, device settings, and printer commands to be generated in a device independent way. For illustrative purposes, the following are examples of three capability files demonstrating a Xerox 6135, an IBM 2000, and a Canon 600.

Capability Files:

```
Xerox 6135
<?xml version=“1.0” encoding=“utf-8”?>
<Capabilities>
  <Device Type=“Xerox 6135” DLL=“XeroxBE.DLL” Description=“Xerox 6135”/>
  <Print Server=“” Queue=“”/>
  <AcceptableFiles PDF=“True”/>
  <Maximums Copies=“99999”/>
  <Element Name=“Cover”>
    <Attribute Name=“Back Cover” Value=“None”>
      <PrinterCommand Cmd=“”/>
    </Attribute>
    <Attribute Name=“Back Cover” Value=“Print Side 1”>
      <PrinterCommand Cmd=“%%XRXcover-back: insideOnly %d %d
%s opaque Plain 0 %d %d”/>
    </Attribute>
    <Attribute Name=“Back Cover” Value=“Print Side 2”>
      <PrinterCommand Cmd=“%%XRXcover-back: outsideOnly %d %d
%s opaque Plain 0 %d %d”/>
    </Attribute>
    <Attribute Name=“Back Cover” Value=“Print Both Sides”>
      <PrinterCommand Cmd=“%%XRXcover-back: both %d %d %s
opaque Plain 0 %d %d”/>
    </Attribute>
    <Attribute Name=“Back Cover” Value=“Preprinted/Blank”>
      <PrinterCommand Cmd=“%%XRXcover-back: nolmage %d %d %s
opaque Plain 0 %d %d”/>
    </Attribute>
    <Attribute Name=“Front Cover” Value=“None”>
      <PrinterCommand Cmd=“”/>
    </Attribute>
    <Attribute Name=“Front Cover” Value=“Print Side 1”>
      <PrinterCommand Cmd=“%%XRXcover-front: outsideOnly %d %d
%s opaque Plain 0 %d %d”/>
    </Attribute>
    <Attribute Name=“Front Cover” Value=“Print Side 2”>
      <PrinterCommand Cmd=“%%XRXcover-front: insideOnly %d %d
%s opaque Plain 0 %d %d”/>
    </Attribute>
    <Attribute Name=“Front Cover” Value=“Print Both Sides”>
      <PrinterCommand Cmd=“%%XRXcover-front: both %d %d %s
opaque Plain 0 %d %d”/>
    </Attribute>
    <Attribute Name=“Front Cover” Value=“Preprinted/Blank”>
      <PrinterCommand Cmd=“%%XRXcover-front: noImage %d %d %s
opaque Plain 0 %d %d”/>
    </Attribute>
  </Element>
  <Element Name=“Finishing”>
    <Attribute Name=“StitchingPosition” Value=“TopLeft”>
      <PrinterCommand Cmd=“%XRXedgeStitching: SinglePortrait”/>
    </Attribute>
  </Element>
  <Constraints>
    <Constraint Name=“Finishing.StitchingPosition” Value=“*”
CName=“InstallableOptions.Stapler” Value=“False” Message=“No Stapler installed”/>
  </Constraints>
  <Limits>
    <LimitElement Name=“Finishing.StitchingPosition” PageCount=“35”
Operator=“gt” Message=“Cannot staple over 35 sheets”/>
  </Limits>
  <InstallableOptions>
    <Option Name=“Stapler” Install=“False”/>
  </InstallableOptions>
</Capabilities>
IBM 2000
<?xml version=“1.0” encoding=“utf-8”?>
<Capabilities>
  <Device Type=“IBM Infoprint 2000” DLL=“IBMBE.DLL” Description=“IBM Infoprint
2000”/>
  <Print Server=“” Queue=“”/>
  <AcceptableFiles PDF=“True”/>
  <Maximums Copies=“99999”/>
  <Element Name=“Cover”/>
    <Attribute Name=“Cover” Value=“”>
      <PrinterCommand Cmd=“%KDKCovers:”/>
    </Attribute>
    <Attribute Name=“Front Cover” Value=“None”>
      <PrinterCommand Cmd=“”/>
    </Attribute>
    <Attribute Name=“Front Cover” Value=“Print Side 1”>
      <PrinterCommand Cmd=“%%%%+ (%s) front simplex frontside”/>
    </Attribute>
    <Attribute Name=“Front Cover” Value=“Print Side 2”>
      <PrinterCommand Cmd=“%%%%+ (%s) front duplex backside”/>
    </Attribute>
    <Attribute Name=“Front Cover” Value=“Print Both Sides”>
      <PrinterCommand Cmd=“%%%%+ (%s) front duplex”/>
    </Attribute>
    <Attribute Name=“Back Cover” Value=“None”>
      <PrinterCommand Cmd=“”/>
    </Attribute>
    <Attribute Name=“Back Cover” Value=“Print Side 1”>
      <PrinterCommand Cmd=“%%%%+ (%s) back simplex frontside”/>
    </Attribute>
    <Attribute Name=“Back Cover” Value=“Print Side 2”>
      <PrinterCommand Cmd=“%%%%+ (%s) back duplex backside”/>
    </Attribute>
    <Attribute Name=“Back Cover” Value=“Print Both Sides”>
      <PrinterCommand Cmd=“%%%%+ (%s) back duplex”/>
    </Attribute>
  </Element>
  <Element Name=“Finishing”>
    <Attribute Name=“StitchingPosition” Value=“TopLeft”>
      <PrinterCommand Cmd=“%%+ staple(front)”/>
      <PrinterCommand Cmd=“%KDKRotation: 0”/>
    </Attribute>
  </Element>
  <Constraints>
    <Constraint Name=“Finishing.StitchingPosition” Value=“*”
CName=“InstallableOptions.Finisher” CValue=“False” Message=“No stapler installed”/>
  </Constraints>
  <Limits>
    <LimitElement Name=“Finishing.StitchingPosition” PageCount=“35”
Operator=“gt” Message=“Cannot staple over 35 sheets”/>
    <LimitElement Name=“Media.DocumentMedia” PageCount=“5”
Operator=“gt” Message=“Exceeded Media Input Bins”/>
  </Limits>
  <InstallableOptions>
    <Option Name=“Stacker” Install=“False”/>
    <Option Name=“Inserter” Install=“False”/>
    <Option Name=“Finisher” Install=“False”/>
    <Option Name=“Booklet Maker” Install=“False”/>
  </InstallableOptions>
</Capabilities>
Canon 600
<?xml version=“1.0” encoding=“utf-8”?>
<Capabilities>
  <Device Type=“Canon iR600-550-60 PS Ver 2.0” DLL=“CanonBE.DLL”
Description=“Canon iR600-550-60 PS Print Server Ver 2.0”/>
  <Print Server=“” Queue=“”/>
  <AcceptableFiles PDF=“False”/>
  <Maximums Copies=“99999”/>
  <Element Name=“Cover”>
    <Attribute Name=“Front Cover” Value=Preprinted/Blank”>
      <PrinterCommand Cmd=“EFInsert” Parameter=“True”/>
    </Attribute>
  </Element>
  <Element Name=“Finishing”>
    <Attribute Name=“StitchingPosition” Value=“TopLeft”>
      <PrinterCommand Cmd=“EFStapler” Parameter=“PUpperLeft”/>
    </Attribute>
  </Element>
  <Constraints>
    <Constraint Name=“Finishing.StitchingPosition” Value=“TopLeft”
CName=“InstallableOptions.Saddle Finisher” CValue=“False” Message=“No stapler
installed”/>
  </Constraints>
  <Limits>
    <LimitElement Name=“Finishing.StitchingPosition” PageCount=“35”
Operator=“gt” Message=“Cannot staple over 35 sheets”/>
    <LimitElement Name=“Finishing.Booklet” PageCount=“15” Operator=“gt”
Message=“Cannot staple booklet over 15 sheets”/>
  </Limits>
  <InstallableOptions>
    <Option Name=“Saddle Finisher” Install=“False”/>
    <Option Name=“CoverInsertor” Install=“False”/>
    <Option Name=“Folder” Install=“False”/>
    <Option Name=“SidePaperDeck” Install=“False”/>
    <Option Name=“Bookmaker” Install=“False”/>
  </InstallableOptions>
</Capabilities>
```

Printer mismatches allow the operator to quickly determine if the specified job ticket settings will be correctly produced on the selected printer. As mentioned above, error conditions fall into one of three categories. These three categories of errors can be placed into one of two types of printer mismatches: (1) Unsupported functions—identifies the supported functionality of the selected printer and includes the first two categories of error conditions discussed above; and, (2) Limitations—identifies the range of supported functionality of the selected printer and includes the last category of errors discussed above. Mismatch messages are shown in list box and listed in the appropriate category: Unsupported items are below a header that states: “Unsupported functionality—You have chosen settings that exceed the capabilities of the selected printer.” Limitations re shown below a header that states: “Device limitations—You have chosen settings that exceed the capabilities of the selected printer.”

For illustrative purposes only, sample messages are listed in the table below:

| Unsupported | | | | | | | | |
|---|---|---|---|---|---|---|---|---|
| function | | Devices | | | | | | |
| Message | Code | DT61xx | IP2000 | IR600 | 265ST | Doc40 | Doc12 | CLC1000 |
| Place at top: You | | | | | | | | |
| have chosen | | | | | | | | |
| settings that the | | | | | | | | |
| selected printer | | | | | | | | |
| does not support. | | | | | | | | |
| This job requests | 005-0001 | X | X | X | | | | ? |
| stapling, but there | | | | | | | | |
| is no stapler | | | | | | | | |
| installed in the | | | | | | | | |
| selected printer. | | | | | | | | |
| This job requests a | 005-0002 | X | X | X | | | | ? |
| booklet, but there | | | | | | | | |
| is no booklet | | | | | | | | |
| maker installed in | | | | | | | | |
| the selected | | | | | | | | |
| printer. | | | | | | | | |
| This job requests | 005-0003 | | | X | | | | ? |
| saddle finishing, | | | | | | | | |
| but there is no | | | | | | | | |
| saddle finisher | | | | | | | | |
| installed in the | | | | | | | | |
| selected printer. | | | | | | | | |
| This job requests | 005-0004 | X | X | | | | | ? |
| stapling a | | | | | | | | |
| transparency, but | | | | | | | | |
| this setting is not | | | | | | | | |
| supported by the | | | | | | | | |
| selected printer. | | | | | | | | |
| The specified | 005-0005 | | | X | X | X | X | X |
| setting, “%s” = “%s”, | | | | | | | | |
| is not supported | | | | | | | | |
| by the selected | | | | | | | | |
| printer. | | | | | | | | |
| This job requests | 005-0006 | | | X | X | X | X | X |
| insert pages, but | | | | | | | | |
| this setting is not | | | | | | | | |
| supported by the | | | | | | | | |
| selected printer. | | | | | | | | |
| This job requests | 005-0007 | | | X | X | X | X | X |
| exception pages, | | | | | | | | |
| but this setting is | | | | | | | | |
| not supported by | | | | | | | | |
| the selected | | | | | | | | |
| printer. | | | | | | | | |
| This job requests | 005-0008 | | | | | X | X | X |
| cover pages, but | | | | | | | | |
| this setting is not | | | | | | | | |
| supported by the | | | | | | | | |
| selected printer. | | | | | | | | |
| This job requests | 005-0009 | | | X | X | X | X | X |
| the following | | | | | | | | |
| settings that are | | | | | | | | |
| not supported by | | | | | | | | |
| the selected | | | | | | | | |
| printer: | | | | | | | | |
| This job requests a | 005-0010 | | | | X | | | ? |
| back cover, but | | | | | | | | |
| this setting is not | | | | | | | | |
| supported by the | | | | | | | | |
| selected printer. | | | | | | | | |
| This job requests | 005-0011 | | | X | X | X | X | X |
| the following | | | | | | | | |
| settings that | | | | | | | | |
| conflict with each | | | | | | | | |
| other: [list | | | | | | | | |
| settings] | | | | | | | | |
| Device | | | | | | | | |
| Limitations | | Devices | | | | | | |
| Message | Code | DT61xx | IP2000 | IR600 | 265ST | Doc40 | Doc12 | CLC1000 |
| Place at top: You | | | | | | | | |
| have chosen | | | | | | | | |
| settings that | | | | | | | | |
| exceed the | | | | | | | | |
| capabilities of the | | | | | | | | |
| selected printer | | | | | | | | |
| This job requests | 005-0015 | X | X | X | X | X | X | ? |
| stapling more than | | | | | | | | |
| 35 sheets, but the | | | | | | | | |
| stapler can only | | | | | | | | |
| staple 35 sheets at | | | | | | | | |
| a time. | | | | | | | | |
| This job requests a | 005-0016 | X | X | | | | | ? |
| booklet with more | | | | | | | | |
| than 22 sheets, but | | | | | | | | |
| the booklet maker | | | | | | | | |
| can only support | | | | | | | | |
| 22 sheets at a | | | | | | | | |
| time. | | | | | | | | |
| This job requests | 005-0017 | X | | | | | | ? |
| binding more than | | | | | | | | |
| 125 sheets, but the | | | | | | | | |
| binder can only | | | | | | | | |
| bind 125 sheets at | | | | | | | | |
| a time. | | | | | | | | |
| This job requests | 005-0018 | X | | | | | | ? |
| binding less than 7 | | | | | | | | |
| sheets, but the | | | | | | | | |
| binder can only | | | | | | | | |
| bind more than 7 | | | | | | | | |
| sheets at a time. | | | | | | | | |

Sample Usage Case 1.

(1) Operator tickets a job and requests binding for the entire job.

(2) Operator then opens invention's Production Print dialog and selects the IBM IP2000 printer (see FIG. 1).

(3) Warning details . . . and Print buttons are highlighted to indicate that Mismatch messages exist.

(4) The operator presses the Warning details . . . button and Warning details are displayed (see FIG. 2). The printer does not support the requested binding setting as shown by the message.

(5) Operator closes the dialog and changes the selection to the DT6135 that he knows has a binder.

(6) The high-light on the printer mismatch button is removed and the operator knows that the specified ticket settings will be used and more importantly that the output will be as desired.

Using the concepts of the present invention, it is possible to automatically select only printers that support the specified ticketed settings. It is also possible to automate the print workflow such that jobs are sent only to printers that support the ticketed settings.

Finally, the representation of printer mismatches may also be shown in a visual/graphical way such that the operator can quickly see what the output will look like depending on which printer is selected.

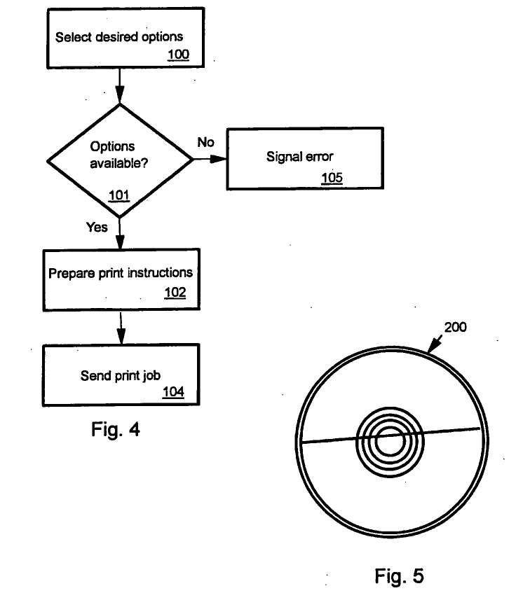

Referring now more particularly to FIG. 4, the steps of the present method are there illustrated in a schematic flow chart. The sequence includes an if then decision point. As has been described above, in a multi-printer environment, a user selects at 100 for a specific print job a device independent set of desired printer options such as stapling, drilling, binding, cover or insert placement and the like. The information handling system associated with the printer, which may be apart from or incorporated within the printer, then compares at 101 the selected options to a definition of printer capabilities and, if the options are available within the defined capabilities, then converts at 102 the device independent options to printer specific commands and sends the print job at 104 to a selected printer which is responsive to the printer specific commands. If the options are unavailable within the defined capabilities, then the system signals an error at 105.

Program instructions implementing the present invention as here described and shown may be distributed on computer readable media such as the disc 200 shown in FIG. 5 and, when executing on a processor, will follow the steps shown in FIG. 4.

In the drawings and specifications there has been set forth a preferred embodiment of the invention and, although specific terms are used, the description thus given uses terminology in a generic and descriptive sense only and not for purposes of limitation.

1. A method comprising the steps of:
in a multi-printer environment, selecting for a specific print job a device independent set of desired printer options;
comparing the selected options to a definition of printer capabilities;
if the options are available within the defined capabilities, then converting the device independent options to printer specific commands; and
sending the print job to a selected printer which is responsive to the printer specific commands; and
if the options are unavailable within the defined capabilities, then signaling an error.

2. A method according to claim 1 further comprising the step of storing a plurality of definitions of printer capabilities, at least two of the stored definitions being in differing command formats.

3. A method according to claim 2 wherein at least three of the stored definitions are in differing command formats.

4. A method according to claim 1 wherein the step of converting device independent options comprises incorporating into a printable format data file commands corresponding to the selected printer options for a selected printer.

5. A method according to claim 1 wherein the step of signaling an error comprises signaling at least a selected one of (a) a message indicating the absence of the desired option capability from printers of a designated type; (b) a message indicating the absence of the desired option capability from a printer of a type which may optionally have the capability; and (c) a message indicating that the requested option capability exceeds to limits available to a printer which has a limited capability for the requested option.

6. Apparatus comprising:
a plurality of printers, each having printer capabilities which vary from other printers in the environment;
an information handling system communicating with said plurality of printers for selectively transmitting thereto specific print jobs, said information handling system having a processor and memory associated with said processor;
program instructions stored in said memory accessibly to said processor and effective when executing on said processor to:
allow an operator to select for a specific print job a device independent set of desired printer options;
retain a set of definitions of printer capabilities for each of said plurality of printers;
compare the operator selected options with a definition of printer capabilities and then
if the options are available within the defined capabilities, then convert the device independent options to printer specific commands; and
send the print job to a selected printer which is responsive to the printer specific commands; and
if the options are unavailable within the defined capabilities, then signal an error.

7. Apparatus according to claim 6 wherein said program instructions when executing on said processor are further effective to store a plurality of definitions of printer capabilities, at least two of the stored definitions being in differing command formats.

8. Apparatus according to claim 7 wherein at least three of the stored definitions are in differing command formats.

9. Apparatus according to claim 6 wherein said program instructions when executing on said processor are further effective to incorporate into a printable format data file commands corresponding to the selected printer options for a selected printer.

10. Apparatus according to claim 6 wherein said program instructions when executing on said processor are further effective to signal at least a selected one of (a) a message indicating the absence of the desired option capability from printers of a designated type; (b) a message indicating the absence of the desired option capability from a printer of a type which may optionally have the capability; and (c) a message indicating that the requested option capability exceeds to limits available to a printer which has a limited capability for the requested option.

11. A program product comprising:
a computer readable medium; and
program instructions stored on said medium accessibly to a processor and effective when executing on said processor to:
allow an operator to select for a specific print job a device independent set of desired printer options;
retain a set of definitions of printer capabilities for each of a plurality of printers;
compare the operator selected options with a definition of printer capabilities and then
if the options are available within the defined capabilities, then convert the device independent options to printer specific commands; and
send the print job to a selected printer which is responsive to the printer specific commands; and
if the options are unavailable within the defined capabilities, then signal an error.

12. A product according to claim 11 wherein said program instructions when executing on a processor are further effective to store a plurality of definitions of printer capabilities, at least two of the stored definitions being in differing command formats.

13. A product according to claim 12 wherein at least three of the stored definitions are in differing command formats.

14. A product according to claim 111 wherein said program instructions when executing on said processor are further effective to incorporate into a printable format data file commands corresponding to the selected printer options for a selected printer.

15. A product according to claim 11 wherein said program instructions when executing on said processor are further effective to signal at least a selected one of (a) a message indicating the absence of the desired option capability from printers of a designated type; (b) a message indicating the absence of the desired option capability from a printer of a type which may optionally have the capability; and (c) a message indicating that the requested option capability exceeds to limits available to a printer which has a limited capability for the requested option.
